(19) United States
(12) Patent Application Publication
(10) Pub. No.: US 2005/0066268 A1
(43) Pub. Date: Mar. 24, 2005

(54) Method for displaying information in an automation system

(76) Inventor: Jurgen Bieber, Ettlingen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/939,306

(22) Filed: Sep. 10, 2004

(30) Foreign Application Priority Data
Sep. 24, 2003 (DE) 10344350.9

(51) Int. Cl. G06F 17/21

(52) U.S. Cl. 715/513

(57) ABSTRACT

The present invention relates to a method for displaying information in an automation system, whereby the current information is displayed repeatedly in a ticker display pane (10), which is integrated within the human-machine interface (100). The current information displayed (11,12,13,14) is process data of the automation system that is displayed on an event-controlled basis in the ticker display pane (10).

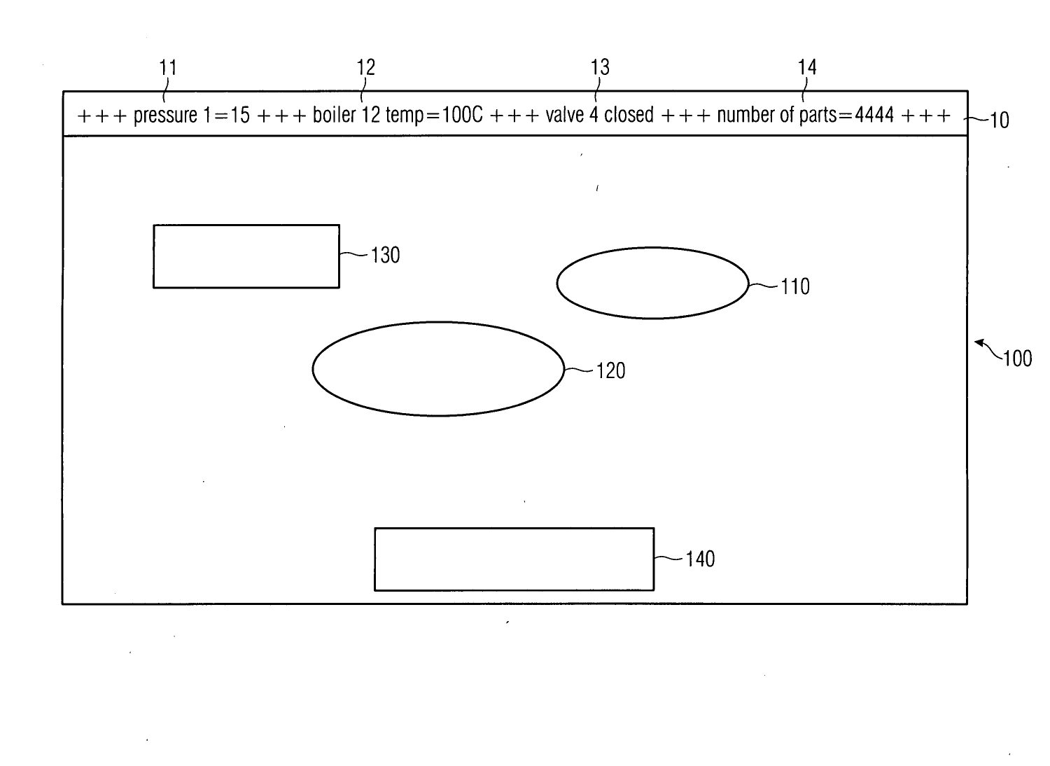

### CROSS REFERENCE TO RELATED APPLICATIONS

This application claims priority to the German application No. 10344350.9, filed Sep. 24, 2003 and which is incorporated by reference herein in its entirety.

### FIELD OF INVENTION

The present invention relates to a method for displaying information in an automation system.

### BACKGROUND OF INVENTION

In automation systems, so-called human-machine interfaces are made available to the user in order to operate and monitor the processes running automatically when the automation system is in operation. The user thereby has the opportunity to call up various process images such as state of the equipment, process plan, other overview diagrams etc. via such an interface, e.g. on a monitor and operate the equipment via a keyboard or a touch screen. Special process data of individual automation components such as a boiler pressure is usually displayed statically in the form of rows of text in the overview diagram.

Displaying current information in a ticker display pane within a human-machine interface is already known from U.S. Pat. No. 6,421,694 B1. The current information made available by several different data providers is repeatedly displayed in the ticker display pane, for example on the desktop of a personal computer. Current information is then displayed in the ticker display pane in a specific sequence determined previously by the various data providers. In this way the current information from various data providers is always displayed repeatedly in an established sequence in the ticker display pane.

The method described previously for displaying process data of an automation system with rows of text and in particular displaying various process data at various locations of an overview diagram can very quickly become confusing for the user. The method known from U.S. Pat. No. 6,421,694 B1 for displaying current information in a ticker display pane is only partly suitable for implementation in an automation system, since according to U.S. Pat. No. 6,421,694 B1, current information is already being displayed in a specific sequence in the ticker display pane with several data providers. With such a method, current modified process data could not be displayed directly to the user.

### SUMMARY OF INVENTION

The object of the present invention is to provide a method, whereby current process data of an automation system can be displayed in a human-machine interface.

This object is achieved by the claims.

As the display of the process data of the automation system in the ticker display pane is event-driven, current information about changes to process data is available to the user immediately and directly. This means that since any change, whether caused by the automation itself or by the user, corresponds to an event in the automation system, every modification is displayed directly in the ticker display pane and represented visually to the user together with other important information.

Further advantageous embodiments and preferred developments of the invention can be found in the dependent claims.

The invention and its advantageous embodiments are described in more detail below with reference to the following FIGURE.

### BRIEF DESCRIPTION OF THE DRAWING

The single FIGURE shows an exemplary embodiment of the invention.

### DETAILED DESCRIPTION OF INVENTION

The part of the human-machine interface 100 represented in the figure which can for example be displayed as a user interface on a monitor, has, as schematically represented, several process images, such as for example the different states of the equipment 110, a process plan 120 and more overview diagrams 140 and 140. Incorporated within this user interface 100 is a ticker display pane 10. The ticker display pane 10 serves to visualize specific current information, i.e. particular process data of the automation system and in particular to continue showing the user this data repeatedly. Thus, as shown in the figure, the ticker display pane in the present example has specific process data giving a pressure state 11, a boiler temperature 12, a valve state 13 and the number of parts produced 14 by the automation system. Within the ticker display pane 10 this current information can be displayed repeatedly scrolling from left to right at a particular speed.

According to the invention, it is essential for the process information to be displayed on an event-driven basis. This means that every change in process data 11-14, whether it was caused by the automation or manually by the user, is immediately incorporated as corresponding information in the ticker display pane 10 or, if this process data 11-14 is already displayed, it is updated directly in the ticker display pane 10. Once the process data to be displayed 11-14 is incorporated in the ticker display pane 10, it is displayed repeatedly in a cycle with the same values until the values of the process data change again.

The ticker display pane 10 represents a configurable visualization component in the user interface 100. As shown in the figure, the ticker display pane 10 can be incorporated as an additional image component in the user interface 100. It is, however, also conceivable for the ticker display pane 10 to be designed as a stand alone web browser version so that it can be incorporated in an Internet environment. If the user then has access to the automation system via the Internet, he/she can have the process data displayed in this manner via a suitable previously configured web browser.

So that the user gains a centered overview of all important process data 11-14 with the ticker display pane 10, this important information must first be stipulated or defined. This means that in particular during the planning of the automation system, it is established which process data 11,12,13,14 should be displayed in the ticker display pane 10 during subsequent operation of the automation system and how the process data to be displayed 11, 12, 13, 14 is transferred during operation from the corresponding data providers to the ticker display pane 10. The ticker display pane 10 has to be configured accordingly in the planning phase. This means that the corresponding data providers have to be chosen, the required information to be displayed selected and the manner in which information is to be transferred from the data providers to the human-machine interface stipulated. In addition, already during the planning phase it can be established how and in what form the ticker display pane 10 is to be integrated in the human-machine interface, i.e. in the user interface of the automation system.

When the human-machine interface 100 is started up, for example when loading the user interface or when calling up a particular Internet page, the ticker display pane 10 connects with the previously configured data providers or registers with them. During the operation of the automation system, the process data 11-14 to be displayed is then transferred to the ticker display pane 10 as XML data by the data providers, such as for example corresponding programmable logic controls, field devices, SCADA systems or databases within the automation system. This transfer takes place via correspondingly planned interfaces between data providers and ticker display pane. In the planning, the synchronization for the transfer should also be established, i.e. when and how the individual process data travels from the data providers of the automation system to the ticker display pane 10. The transfer can take place for example both via proprietary interfaces using “OLE for Process Control” (OPC) and via standardized web interfaces using “Open Database Connectivity” (ODBC). Thereby the ticker display pane 10 is provided with the current important process data 11-14 in accordance with the planning previously carried out and this data is shown by the ticker display pane 10.

The present invention was until now described in the embodiment shown in the figure. Further embodiments are conceivable and included in the present invention. Thus, as already described above, the configuration of the ticker display pane 10, i.e. what and how process data is presented in the ticker display pane is established during the planning phase. This configuration can, however, be modified again simply at a later point in time, according to the requirements of the user especially during operation. In addition, it is also feasible that several ticker display panes could be integrated in a single user interface. The ticker display pane 10 shown in the figure should only represent one embodiment. Various other items, other types and sizes of font or color could be used to highlight this important information to be displayed visually in the ticker display pane for the users. It is important in all these embodiments that the fundamental idea behind the invention is fulfilled, namely that important process data is clear to the user of an automation system and that up-to-date data is displayed immediately.

1-4. (cancelled)

5. A method for displaying current information in an automation system, comprising:
displaying current information repeatedly in a ticker display pane which is integrated within a human-machine interface, wherein
the displayed current information is process data of the automation system and is displayed on an event-driven basis in the ticker display pane.

6. The method according to claim 5, further comprising:
determining during the planning of the automation system which process data can be displayed in the ticker display pane during operation of the automation system; and
determining how the process data which can be displayed is transferred to the ticker display pane during operation of the automation system.

7. The method according to claim 6, wherein the process data is transferred as XML data from one or more data providers in an automation system to the ticker display pane in the human-machine interface.

8. The method according to claim 5, wherein the human-machine interface is a user interface for operating and monitoring, which presents various process images during the operation of the automation system, and wherein in the user interface the ticker display pane is visually highlighted.

9. The method according to claim 8, wherein in the user interface the ticker display pane is visually highlighted in relation to the process images.

10. The method according to claim 6, wherein the human-machine interface is a user interface for operating and monitoring, which presents various process images during the operation of the automation system, and wherein in the user interface the ticker display pane is visually highlighted.

11. The method according to claim 7, wherein the human-machine interface is a user interface for operating and monitoring, which presents various process images during the operation of the automation system, and wherein in the user interface the ticker display pane is visually highlighted.
